(19) United States
(12) Patent Application Publication
(10) Pub. No.: US 2020/0382524 A1
(43) Pub. Date: Dec. 3, 2020

(54) SYSTEM AND METHOD FOR A SECURE NETWORK

(71) Applicant: Brownie Technologies Ltd., Petach-Tikva (IL)

(72) Inventors: Hana-Muriel SETTEBOUN, Tel-Aviv (IL); Netanel ROBIN, Tel-Aviv (IL)

(73) Assignee: Brownie Technologies Ltd., Petach-Tikva (IL)

(21) Appl. No.: 16/423,281

(22) Filed: May 28, 2019

(51) Int. Cl. H04L 29/06; G06N 3/02

(52) U.S. Cl. CPC H04L 63/1416; H04L 63/1433; G06N 3/02; H04L 63/1425; H04L 63/20

(57) ABSTRACT

A secure network system comprising: at least one secured network connected device, comprising at least one hardware processor connected to at least one digital communication network interface, and adapted for: in at least one iteration of a plurality of iterations: executing a binary code for computing a maliciousness score in response to an input message, where the binary code is received from a remote server via a network and encapsulates a classification model trained, using a plurality of historical messages collected by the remote server from a plurality of devices, to compute the maliciousness score in response to the input message; receiving a message via the at least one network interface; computing a message maliciousness score by providing the message to the binary code; and providing the message to a software object executed by the hardware processor to perform a message oriented task, subject to the message maliciousness score.

### FIELD AND BACKGROUND OF THE INVENTION

The present invention, in some embodiments thereof, relates to a digital communication network and, more specifically, but not exclusively, to a digital communication network providing secure connectivity to a plurality of home utility metering devices.

There is a continuous increase in use of digital communication networks in a variety of services and solutions. Some examples of areas where one or more digital communication networks may be used by a service are home automation solutions—automating the ability to control items around the house—such as Amazon Echo and Philips Hue, telecommunication services, health care solutions such as Philips eCareCoordinator and Connected Home Living, and critical utility infrastructures such as electrical power grids, water utilities and gas supply networks. Some such systems, specifically, but not exclusively, critical utility infrastructures, are becoming susceptible to cyber-attacks, i.e. one or more attacks targeting, and additionally or alternatively exploiting, digital technology such as a digital communication network and digital information. An attacker is an entity—a person or an organization—attempting to benefit from disrupting a service and additionally or alternatively from gaining unauthorized access to the service. An attacker may attack a system via a digital communication network used by the system for the purpose of achieving one or more goals, some examples of goals being disrupting a service provided by the system, gaining unauthorized access to the service, gaining unauthorized access to private data of the service, and forging financial transactions for example for billing frauds. For example, when the system is a power grid supplying electrical power to a plurality of clients, an attacker may cause a power outage for one or more clients or disruption to power supply to the one or more clients. An attacker may cause an entire power grid to shut down.

In addition, there is an increase in use of network connected home utility metering devices. Some examples of a network connected home utility metering device are an electrical power meter, a water meter, and a gas meter. Such metering devices are also known as smart utility meters. A smart utility meter is also known as an advanced utility meter. Advanced metering infrastructure (AMI) is an architecture for automated, two-way communication between a smart utility meter and a computerized server of company providing a utility service. A home area network (HAN) is a digital communication network that operates within a house or small office/home office (SOHO) and connects digital devices within the home or office. Some smart utility meters are additionally connected to one or more appliances, over a HAN. For example, a smart electricity utility meter may be connected to one or more electrical appliances in a home, such as a refrigerator or an air conditioner. A smart gas utility meter may be connected to one or more gas appliances, such as a furnace or an oven. Some HANs connect digital devices using a wired digital communication network technology, for example coaxial cable, twisted pair cable and power line communication. Some HANs connect digital devices using a wireless digital communication network technology, for example a network based on Institute of Electrical and Electronics Engineers (IEEE) 802.11 technical standard and a network based on IEEE 802.15.4 technical standard. In another possible threat, an attacker on a system having one or more smart utility meters may forge a meter reading to lower a bill and fraudulently reduce an amount of money due to a utility company providing the utility service.

There is a need to reduce a risk of a cyber-attack on a network provided service.

### SUMMARY OF THE INVENTION

It is an object of the present invention to provide a system and a method for providing secure network communication between a network connected device and a remote server.

The foregoing and other objects are achieved by the features of the independent claims. Further implementation forms are apparent from the dependent claims, the description and the figures.

According to a first aspect of the invention, a secure network system comprises at least one secured network connected device, comprising at least one hardware processor connected to at least one digital communication network interface, and adapted for: in at least one iteration of a plurality of iterations: executing a binary code for computing a maliciousness score in response to an input message, where the binary code is received from a remote server via a network and encapsulates a classification model trained, using a plurality of historical messages collected by the remote server from a plurality of secured network connected devices, to compute the maliciousness score in response to the input message; receiving a message via the at least one digital communication network interface; computing a message maliciousness score by providing the message to the binary code; and providing the message to at least one software object executed by the at least one hardware processor to perform a message oriented task, subject to the message maliciousness score.

According to a second aspect of the invention, a method for a secured network connected device comprises in at least one iteration of a plurality of iterations: executing a binary code for computing a maliciousness score in response to an input message, where the binary code is received from a remote server via a network and encapsulates a classification model trained, using a plurality of historical messages collected by the remote server from a plurality of secured network connected devices, to compute the maliciousness score in response to the input message; receiving a message via the at least one digital communication network interface; computing a message maliciousness score by providing the message to the binary code; and providing the message to at least one software object executed by at least one hardware processor of the secured network connected device to perform a message oriented task, subject to the message maliciousness score.

According to a third aspect of the invention, a secure network system comprises at least one server, comprising at least one hardware processor adapted for: in each of a plurality of server iterations: receiving from a plurality of secured network devices a plurality of messages; training a classification model to compute a maliciousness score in response to an input message; producing a binary code encapsulating the classification model; and sending the binary code, via a network, to at least one secured network connected device.

According to a fourth aspect of the invention, a method for a server of a secure network comprises in each of a plurality of server iterations: receiving from a plurality of secured network devices a plurality of messages; training a classification model to compute a maliciousness score in response to an input message; producing a binary code encapsulating the classification model; and sending the binary code, via a network, to at least one secured network connected device.

According to a fifth aspect of the invention, a method for a secure network system comprises on at least one remote server: in each of a plurality of server iterations: receiving from a plurality of secured network devices a plurality of messages; training a classification model to compute a maliciousness score in response to an input message; producing a binary code encapsulating the classification model; and sending the binary code, via a network, to at least one secured network connected device; and on the at least one secured network connected device: in at least one iteration of a plurality of iterations: receiving the binary code from the at least one remote server; executing the binary code; receiving a message via at least one digital communication network interface; computing a message maliciousness score by providing the message to the binary code; and providing the message to at least one software object executed by the at least one hardware processor to perform a message oriented task, subject to the message maliciousness score.

According to a sixth aspect of the invention, a secure network system comprises at least one remote server, comprising at least one server hardware processor adapted for: in each of a plurality of server iterations: receiving from a plurality of secured network devices a plurality of messages; training a classification model to compute a maliciousness score in response to an input message; producing a binary code encapsulating the classification model; and sending the binary code, via a network, to at least one secured network connected device; and at least one secured network connected device, comprising at least one hardware processor connected to at least one digital communication network interface, and adapted for: in at least one iteration of a plurality of iterations: receiving the binary code from the at least one remote server; executing the binary code; receiving a message via at least one digital communication network interface; computing a message maliciousness score by providing the message to the binary code; and providing the message to at least one software object executed by the at least one hardware processor to perform a message oriented task, subject to the message maliciousness score.

With reference to the first and second aspects, in a first possible implementation of the first and second aspects of the present invention the binary code encapsulates a plurality of hardware components and a plurality of software components of the classification model. Encapsulating the plurality of hardware components and plurality of software components of the classification model facilitates executing the classification model on the at least one hardware processor of the at least on secured network connected device, without requiring additional processing circuitry and without requiring bespoke processing circuitry for executing the classification model, thus reducing cost of production of the secured network connected device and additionally or alternatively reducing cost of operation of the secured network connected device by reducing power consumption of the secured network connected device.

With reference to the first and second aspects, in a second possible implementation of the first and second aspects of the present invention the at least one digital communication network interface is connected to a wireless digital communication network. Optionally, the wireless digital communication network is selected from a group consisting of: a network based on Institute of Electrical and Electronics Engineers (IEEE) 802.15.4 technical standard, and a cellular network. Optionally, the network based on IEEE 802.15.4 technical standard is a Zigbee Alliance Zigbee network. Optionally, the cellular network is a Global System for Mobile communications (GSM) network. Optionally, the at least one hardware processor is connected to the network via at least one other digital communication network interface. Using a wireless digital communication network facilitates implementing the present invention in an Internet of Things based system, thus increasing security of an Internet of Things solution. In addition, using one or more wireless digital communication networks facilitates connecting the at least one device to a remote server located at a location other than a location of the at least one device and additionally or alternatively to one or more other devices without requiring infrastructure of a wired network connection, reducing cost of installation of a system based on the present invention.

With reference to the first and second aspects, in a third possible implementation of the first and second aspects of the present invention the classification model is a neural network. Optionally, the neural network comprises a plurality of computation units and a plurality of node connections, each node connection having a source node of the plurality of computation units, a target node of the plurality of computation units, and a plurality of connection values. Optionally, the binary code encapsulates a plurality of compressed computation units, each a compressed representation of one of the plurality of computation units, and a plurality of compressed node connections, each a compressed representation of one of the plurality of node connections. Optionally, executing the binary code comprises: expanding at least some of the compressed computation units to produce a plurality of expanded computation units, and in at least one of a plurality of classification iterations: executing at least one of the expanded computation units; expanding at least one of the plurality of compressed node connections having a source node equal to the at least one of the expanded computation units to produce an expanded node connection; and executing the target node of the expanded node connection according to an output of the source node and the plurality of connection values of the expanded node connection. Expanding a node connection, and additionally or alternatively a computation unit, only when needed facilitates reducing an amount of digital memory required to compute the maliciousness score, thus reducing cost of manufacturing the at least one secured network connected device.

With reference to the first and second aspects, in a fourth possible implementation of the first and second aspects of the present invention the at least one hardware processor is further adapted for: in the at least one iteration: receiving another message via the at least one digital communication network interface; computing another message maliciousness score by providing the other message to the binary code; and providing the other message to the at least one software object to perform the message oriented task, subject to the other message maliciousness score. Providing more than one message to the at least one software object subject to a computing a respective message maliciousness score for each of the more than one message facilitates increasing security of the system.

With reference to the first and second aspects, in a fifth possible implementation of the first and second aspects of the present invention the at least one hardware processor is further adapted for: in at least one other iteration of the plurality of iterations: receiving from the remote server, via the network, another binary code for computing a maliciousness score in response to an input message; where the other binary code encapsulates the classification model further trained, using another plurality of historical messages collected by the remote server from the plurality of secured network connected devices, to compute the maliciousness score in response to the input message; and replacing the binary code with the other binary code. Updating the classification model with the classification model further trained facilitates increasing accuracy of an output of the classification model. Optionally, the at least one hardware processor is further adapted for: sending the message to the remote server for training the classification model. Training the classification model using the message increases accuracy of an output of the classification model.

With reference to the first and second aspects, in a sixth possible implementation of the first and second aspects of the present invention the at least one hardware processor is further adapter for: identifying at least one signature-based anomaly by computing a match between the message and at least one identified signature value; and refraining from providing the message to the binary code subject to identifying the at least one signature based anomaly. Optionally, the at least one identified signature value is a regular expression string value. Computing a match between the message and at least one signature-based anomaly value facilitates increasing security of the system. Using a regular expression string value as an identified signature value increases processing throughput of the at least one secured network connected device.

With reference to the first and second aspects, in a seventh possible implementation of the first and second aspects of the present invention the at least one hardware processor is further adapted for: classifying the message as malformed, subject to a result of applying at least one message-format test to the message; sending a validation request, comprising at least part of the message, to the remote server for classification; receiving from the remote server a validation value; and refraining from providing the message to the other software object subject to the validation value. Refraining from providing the message to the other software object subject to a validation value received from the remote server increases security of the system reducing a probability of processing a malicious message and increasing a probability of processing a valid message.

With reference to the first and second aspects, in an eighth possible implementation of the first and second aspects of the present invention the at least one hardware processor is further adapted for: classifying the message as verified, subject to a result of applying at least one syntax test to the message; and providing the message to the at least one software object instead of computing the message maliciousness score and providing the message to the at least one software object subject to the message maliciousness score. Optionally, the at least one digital communication interface is connected to a GSM network. Optionally, applying the at least one syntax test comprises at least one of: comparing a command value extracted from the message to an identified command value; comparing a flag value extracted from the message to an identified flag value; comparing an amount of bytes of the message to an identified amount of bytes, comparing an encryption method value identified in the message to an identified encryption method value, and comparing a routing attribute value extracted from the message to an identified routing attribute value. Providing the message to the at least one software object subject to a result of applying at least one syntax test to the message facilitates increasing processing throughput of the at least one secured network connected device and reducing processing latency of the at least one secured network connected device.

With reference to the third and fourth aspects, in a first possible implementation of the third and fourth aspects of the present invention the at least one hardware processor is further adapted for: computing a plurality of digital signatures, each computed using one of the plurality of messages; associating a maliciousness score to each of the plurality of messages; and storing the plurality of messages as a plurality of historical messages in at least one non-volatile digital storage connected to the at least one hardware processor, each of the plurality of messages stored with respective maliciousness score and respective digital signature. Optionally, the at least one hardware processor is further adapted for: in at least one of a plurality of validation iterations: receiving from the at least one secured network connected device a validation request, comprising at least part of a message; computing a digital signature using the at least part of the message; computing a validation value by comparing the digital signature to a plurality of digital signatures of the plurality of historical messages; and sending the validation value to the at least one secured network connected device. Producing a plurality of historical messages each associated with a respective maliciousness score and a respective digital signature facilitates increasing accuracy of an output of a classification model trained using the plurality of historical messages and facilitates reducing computation latency of computing a validation value.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic block diagram of an exemplary system, according to some embodiments of the present invention;

FIG. 2 is a flowchart schematically representing an optional flow of operations for a device, according to some embodiments of the present invention;

FIG. 3 is a flowchart schematically representing an optional flow of operations for executing an encapsulated classification model, according to some embodiments of the present invention;

FIG. 4 is a flowchart schematically representing an optional flow of operations for a server, according to some embodiments of the present invention;

FIG. 5 is a flowchart schematically representing an optional flow of operations for updating an encapsulated classification model, according to some embodiments of the present invention; and

FIG. 6 is a flowchart schematically representing an optional flow of operations for validating a message on a server, according to some embodiments of the present invention.

### DESCRIPTION OF SPECIFIC EMBODIMENTS OF THE INVENTION

The present invention, in some embodiments thereof, relates to a digital communication network and, more specifically, but not exclusively, to a digital communication network providing secure connectivity to a plurality of home utility metering devices.

For brevity, henceforth the term “network” is used to mean a digital communication network. As used herein, the term “digital communication network” includes, but is not limited to, a Local Area Network (LAN) or a HAN, for example an Ethernet network, a WiFi network or a ZigBee Alliance ZigBee network, and a Wide Area Network (WAN), for example a cellular network or the Internet.

In the area of Internet of Things (IoT), there exist solutions for provisioning and authenticating an IoT device to allow the IoT device to communicate in an identified network. However, such solutions do not address malicious attacks on an IoT device, where network traffic to or from an authenticated and authorized IoT device is tampered with, for the purpose of interfering with operation of the IoT device and additionally or alternatively operation of a remote server.

There is a trend to reduce costs of smart meter devices, therefore a smart meter device may have limited computing resources. There is a need for a secure solution which requires low computation power and additionally or alternatively requires a small amount of memory, so the secure solution may be executed by a smart meter device without increasing cost of manufacturing the smart meter device, while at the same time being efficient enough so as not to reduce the smart meter device's performance, for example not increasing processing latency or reducing processing throughput of the smart meter device.

For brevity, henceforth the term “device” means a network connected device. The network connected device may be specifically, but not exclusively, a smart utility meter. The network connected device may be a secured network connected device, implementing one or more methods of reducing a risk of being attacked.

The present invention, in some embodiments thereof, proposes using a message maliciousness score computed on a device for a message received by the device to determine whether to further process the message, where the message maliciousness score is indicative of a probability that further processing the message will disrupt operation of the device or of a service. In some embodiments of the present invention the input message is further processed on the device subject to the message maliciousness score such that an input message suspected to pose a risk to the device or the service is not processed. To reduce an amount of computing resources required on a device of a system providing a service, the present invention, in some embodiments thereof, proposes computing the message maliciousness score on the device by providing the message to binary code, executing on at least one hardware processor of the device, encapsulating a classification model trained to compute a maliciousness score in response to an input message, where the classification model is received from a remote server, optionally via a network. Optionally the classification model is trained using a plurality of historical messages collected by the remote server from a plurality of devices. Using a classification model trained using a plurality of historical messages collected by the remote server increases accuracy of a maliciousness score computed by the classification model. As the classification model is trained by the remote server the device does not need computing resources to train the classification model, facilitating reducing an amount of computing resources on the device, thus reducing cost of production and cost of operation of the device. In addition, training the classification model by the remote server facilitates providing one trained model to a plurality of devices, reducing an amount of computing resources needed to provide a trained classification model to each of the plurality of devices, thus reducing cost of deployment and cost of operation of a system implemented according to the present invention.

In addition, in some embodiments of the present invention, the classification model encapsulates a plurality of hardware components and a plurality of software components of the classification model, reducing a need for additional processing circuitry on the device, dedicated to execution of a classification model, thus reducing cost of production and cost of operation of the device.

In some embodiments of the present invention, the classification model is a neural network. Optionally, the neural network comprises a plurality of computation units and a plurality of node connections, Optionally, the binary code encapsulates a plurality of compressed computation units, each a compressed representation of one of the plurality of computation units, and a plurality of compressed node connections, each a compressed representation of one of the plurality of node connections. According to the present invention, in some embodiments executing the binary code to compute the maliciousness score comprises expanding at least some of the compressed computation units and expanding some of the plurality of compressed node connections and some other computation units only when needed for the computation. Expanding a node connection, and additionally or alternatively a computation unit, only when needed for the computation facilitates reducing an amount of digital memory required to compute the maliciousness score, thus reducing cost of manufacturing the device.

In addition, the present invention in some embodiments thereof, proposes sending the message to the remote server for training the classification model, thus increasing accuracy of a maliciousness score computed by the classification model. Optionally, the classification model encapsulated in the binary code is updated by the device receiving another binary code encapsulating the classification model further trained. Optionally, the classification model is further trained using another plurality of historical messages collected by the remote server from the plurality of devices. Optionally, the classification model is updated periodically. Further training the classification model and using the further trained classification model increases accuracy of the maliciousness score computed by the classification model, thus increasing system security.

Optionally, one or more signature-based anomalies are identified by computing a match between the message and one or more identified signature values. An example of a signature value is a regular expression string value. Optionally the signature value is indicative of a signature of a known abnormal message. When the one or more signature-based anomalies are identified the message is optionally not provided to the binary code, thus reducing computation time which in turn reduces processing latency in the device's operation. In addition, when the one or more signature-base anomalies are identified the message is optionally not further processed, thus increasing system security.

In addition, the present invention proposes, in some embodiments, applying one or more message-format tests to the message and classifying the message as malformed subject to a result of applying the one or more message-format tests. In such embodiments, the message is not presented to the binary code subject to classifying the message as malformed, reducing processing latency and increasing processing throughput as a malformed message is not processed by the classification model.

In some embodiments, the present invention proposes sending a validation request to the remote server for classification, and the message is not further processed subject to a validation value received from the remote server. Optionally, the message is not presented to the binary code subject to the validation value. Using a validation value, received from the remote server, to refrain from further processing a message increases security of the system.

According to the present invention, in some embodiments when the remote server receives the validation request from the device, the remote server computes a digital signature using at least part of the message and computes the validation value by comparing the digital signature to a plurality of known digital signatures. Optionally, each of the plurality of known digital signatures is computed for one of a plurality of messages received by the remote server. Optionally each of the plurality of messages is associated with a maliciousness score. Optionally the remote server stores each of the plurality of messages with respective digital signature and with respective maliciousness score. Using a digital signature reduces an amount of time required to compare the digital signature to the plurality of digital signatures. Using a repository of historical messages and associated maliciousness scores reduces an amount of time required to identify the message as malicious, thus reducing processing latency and increasing processing throughput of the remote server.

In addition, the present invention proposes, in some embodiments, applying on the device one or more syntax tests to the message and classifying the message as verified subject to a result of applying the one or more syntax tests and further processing the message without computing the message maliciousness score. Classifying the message as verified using the one or more syntax tests reduces processing latency and increases processing throughput as a message classified as verified is not processed by the classification model. Optionally, a syntax test is applied when the message is received via a Global System for Mobile communications (GSM) network. Some examples of a syntax test are a test comprising one or more of the following: comparing a command value extracted from the message to an identified command value; comparing a flag value extracted from the message to an identified flag value; comparing an amount of bytes of the message to an identified amount of bytes, comparing an encryption method value identified in the message to an identified encryption method value, and comparing a routing attribute value extracted from the message to an identified routing attribute value.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

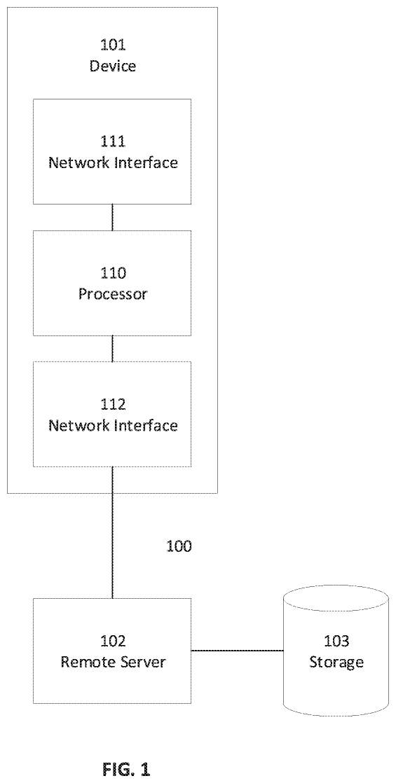

Reference is now made to FIG. 1, showing a schematic block diagram of an exemplary system 100, according to some embodiments of the present invention. In such embodiments, at least one device 101 comprises at least one hardware processor 110 and at least one digital communication network interface 111. For brevity, henceforth the term “at least one network interface” is used to mean “at least one digital communication network interface”, and the term “processor” is used to mean “at least one hardware processor”. Optionally, at least one device 101 comprises at least one other network interface 112. Optionally, processor 101 is electrically connected to network interface 111, optionally for the purpose of receiving one or more messages. Optionally, network interface 111 is connected to at least one wireless digital communication network. Some examples of a wireless digital communication network are a network based on IEEE 802.15.4 technical standard, for example a Zigbee Alliance Zigbee network, a network based on IEEE 802.11 technical standard, and a cellular network, for example a GSM network. Optionally, processor 101 is electrically connected to network interface 112. Optionally, network interface 112 is connected to at least one other wireless network. Optionally, processor 101 receives at least some of the one or more messages via network interface 112. For example, in some embodiments of the present invention network interface 111 is connected to a network based on IEEE 802.15.4 technical standard and other network interface 112 is connected to a cellular network. Optionally, network interface 111 is network interface 112.

Optionally, at least one device 101 is connected remote server 102, optionally via at least one other network interface 112. Optionally, remote server 102 comprises at least one other hardware processor. Optionally, remote server 102 is connected to one or more non-volatile digital storages 103, optionally for the purpose of storing a plurality of historical messages. Some examples of a non-volatile digital storage are a hard disk drive, a network connected storage and a storage network.

To provide a secure digital communication network, system 100 implements, in some embodiments of the present invention, the following optional method.

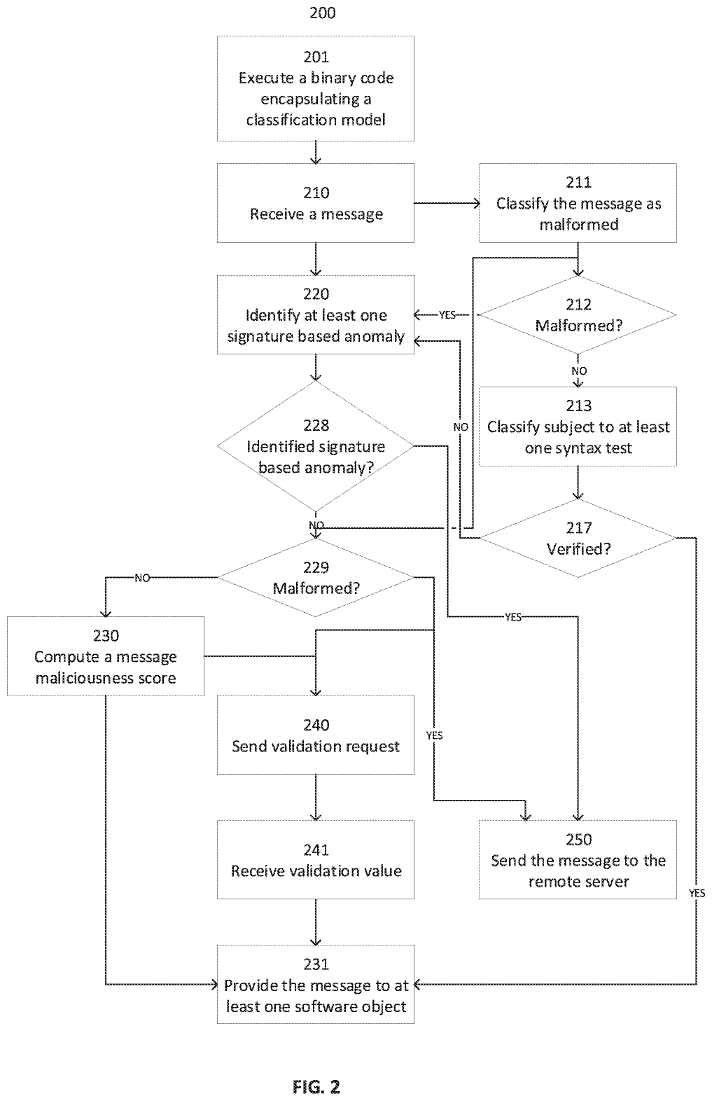

Reference is now made also to FIG. 2, showing a flowchart schematically representing an optional flow of operations 200 for a device, according to some embodiments of the present invention. In such embodiments, in 201 processor 110 executes a binary code for computing a maliciousness score in response to an input message. Optionally, the binary code is received from remote server 102, optionally via network interface 112. Optionally, the binary code encapsulates a classification model trained to compute the maliciousness score in response to the input message. Optionally, the classification model is trained using a plurality of historical messages collected by remote server 102 from a plurality of secured network connected devices. Optionally, the binary code encapsulates a plurality of hardware components and a plurality of software components of the classification model. Optionally, the classification model is a neural network. Optionally, the neural network comprises a plurality of computation units and a plurality of node connections, each indicative of a connection between two of the plurality of computation units. Optionally, each node connection has a source node of the plurality of computation units and a target node of the plurality of computation units. Optionally each node connection has a plurality of connection values. Optionally, the binary code encapsulates a plurality of compresses computation units, each a compressed representation of one of the plurality of computation units, and a plurality of compressed code connections, each a compresses representation of one of the plurality of node connections.

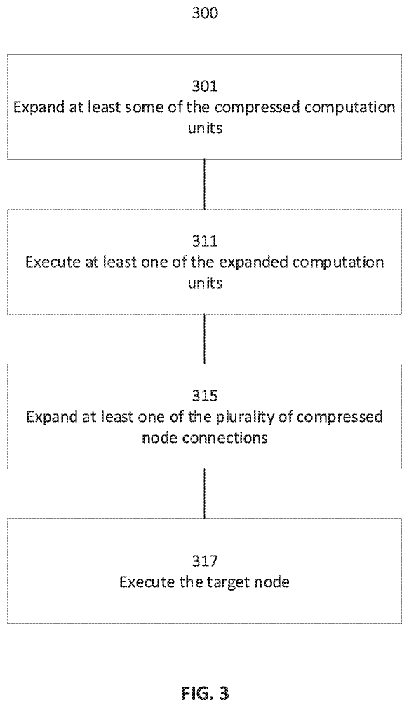

Reference is now made also to FIG. 3, showing a flowchart schematically representing an optional flow of operations 300 for executing an encapsulated classification model, according to some embodiments of the present invention. In such embodiments, in 301 processor 110 expands at least some of the compressed computation units to produce a plurality or expanded computation units. In 311, processor 110 optionally executes at least one of the expanded computation units. In 315, processor 110 optionally expands at least one of the plurality of compressed node connections having a source node equal to the at least one of the expanded computation units executed in 311, to produce an expanded node connection, and in 317 processor 110 optionally executes the target node of the expanded node connection produced in 315. Optionally processor 110 executes the target node of the expanded node connection according to an output of the source node and the plurality of connection values of the expanded node connection. Optionally, 311, 315 and 317 are executed in one of a plurality of classification iterations. Optionally, 311, 315, and 317 are executed in more than one classification iteration.

Reference is now made again to FIG. 1. Optionally, processor 110 executes a plurality of iterations. Optionally, processor 110 executes the binary code in 201 in at least one iteration of the plurality of iterations. Optionally, in the at least one iteration, processor 110 receives in 210 a message via network interface 111. Optionally, processor 110 receives the message via other network interface 112. In 230, processor 110 optionally computes a message maliciousness score by providing the message to the binary code, and in 231 processor 110 optionally provides the message to at least one software object executed by the at least one hardware processor to perform a message oriented task, subject to the message maliciousness score. Optionally, the message maliciousness score is a numerical value. For example, processor 110 may provide the message to the at least one software object for the purpose of forwarding to another device connected to at least one device 101 subject to the message maliciousness score being a value less than an identified threshold score value. In another example processor 110 may provide the message to the at least one software object for the purpose of modifying one or more device values of the device, subject to the message maliciousness score being a value equal to the identified threshold value. In yet another example processor 110 may provide the message to the at least one software object for the purpose of modifying one or more device values of the device, subject to the message maliciousness score being in an identified range of threshold values. Optionally, the message maliciousness score is a binary maliciousness value, selected from a group consisting of two identified maliciousness values, for example true and false.

Optionally, processor 110 executes 201, 210, 230 and 231 in more than one of the plurality of iterations, such that in processor 110 receives in 210 another message, optionally via network interface 111 or network interface 112, in 230 processor 110 optionally computes another message maliciousness score by providing the other message to the binary code, and in 231 processor 110 optionally provides the other message to the at least one other software object to perform the message oriented task, subject to the other message maliciousness score.

Optionally, processor 110 computes the message maliciousness score in 230 subject to classifying the message in 229 as not being malformed, optionally by applying in 211 one or more message-format tests to the message. Some examples of a message format test are comparing an amount of bytes of the message to a threshold amount of bytes, and comparing a checksum value computed for the message to an extracted checksum value extracted from the message.

In 240, processor 110 optionally sends to remote server 102 a validation request, optionally subject to classifying the message as malformed in 229. Optionally, the validation request comprises at least part of the message, optionally for classification by remote server 102. Optionally, processor 110 receives in 241 a validation value and subject to the validation value processor 110 optionally executes 231. Optionally, subject to the validation value, processor 110 refrains from providing the message to the at least one software object, and does not execute 231.

Optionally, processor 110 identifies in 228 one or more signature-based anomalies by optionally computing in 220 a match between the message and one or more identified signature values. An example of a signature value is a regular expression string value. Optionally, the regular expression string value is indicative of a signature of a known abnormal message. Optionally, processor 110 identifies the one or more signature-based anomalies before computing the message maliciousness score in 230.

Optionally, processor 110 classifies the message as malformed in 212, optionally subject to the result of applying the one or more message-format tests to the message in 211. Optionally, processor 110 identifies in 220 the one or more signature-based anomalies after classifying the message as malformed in 212. In 213 processor 110 optionally applies one or more syntax tests to the message, optionally after classifying the message as not malformed in 212. Optionally, the one or more syntax tests comprise one or more of the following: comparing a command value extracted from the message to an identified command value; comparing a flag value extracted from the message to an identified flag value; comparing an amount of bytes of the message to an identified amount of bytes, comparing an encryption method value identified in the message to an identified encryption method value, and comparing a routing attribute value extracted from the message to an identified routing attribute value. Optionally, in 217 processor 110 classifies the message as verified, subject to a result of applying the one or more syntax tests to the message. Optionally, processor 110 provides the message to the at least one other software object in 231 subject to classifying the message as verified. Optionally, processor 111 provides the message to the at least one other software object in 231 subject to classifying the message as verified in 217 instead of computing the message maliciousness score in 230 and providing the message to the at least one other software object in 231 subject to the message maliciousness score computed in 230.

Optionally, in 250, processor 110 sends the message to remote server 102, optionally for the purpose of training the classification model. Optionally, processor 110 sends the message to remote server 102 after identifying a signature-based anomaly in 220. Optionally, processor 110 sends the message to remote server 102 after classifying the message as malformed in 229. Optionally, processor 110 sends the message to remote server 102 after computing the message maliciousness score in 230, optionally subject to the message maliciousness score.

In some embodiments of the present invention server 102 trains the classification model. Additionally or alternatively, server 102 optionally produces a repository of historical messages. To do so, in some embodiments of the present invention system 100 implements the following optional method.

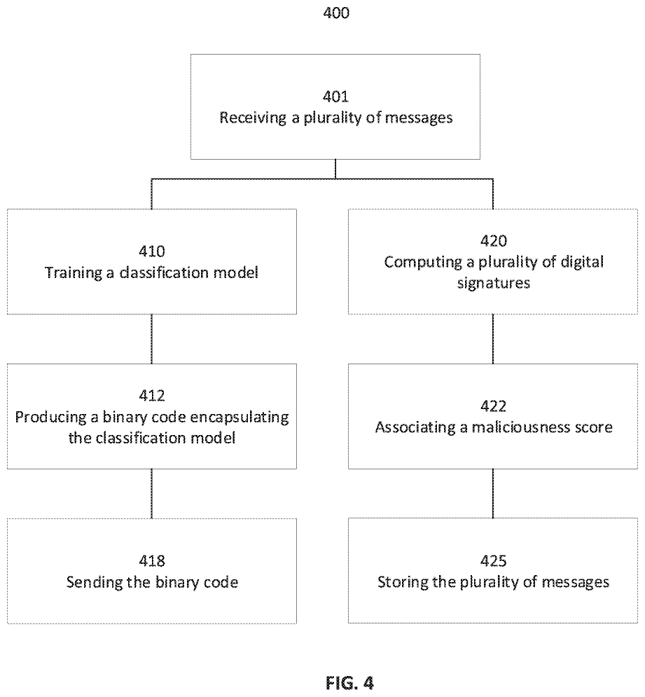

Reference is now made also to FIG. 4, showing a flowchart schematically representing an optional flow of operations 400 for a server, according to some embodiments of the present invention. In such embodiments, in each of a plurality of server iterations, in 401 remote server 102 receives a plurality of messages from a plurality of secured network devices. Optionally, the plurality of messages includes the message sent to remote server 102 from at least one device 101 in 250 described above. In 410, remote server 102 optionally trains a classification model to compute a maliciousness score in response to an input message. Optionally, remote server 102 produces in 412 a new binary code encapsulating the classification model and in 418 remote server 102 optionally sends the binary code to at least one device 101, optionally via a network, for example via network interface 112.

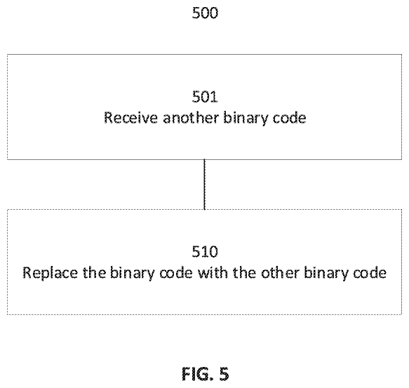

Upon receiving the new binary code, at least one device 101 optionally implements the following method. Reference is now made also to FIG. 5, showing a flowchart schematically representing an optional flow of operations 500 for updating an encapsulated classification model, according to some embodiments of the present invention. In such embodiments, in at least one other of the plurality of iterations, processor 110 receives in 501 another binary code for computing a maliciousness score in response to an input message, for example the new binary code. Optionally, the other binary code encapsulates the classification model further trained to compute the maliciousness score in response to the input message, for example the classification model trained in 410 in an identified server iteration of the plurality of server iterations. Optionally, the classification model is further trained using another plurality of historical messages collected by remote server 102 from the plurality of secured network connected devices, for example the plurality of messages received from the plurality of secured network connected devices in 401 in the identified server iteration. In 410, processor 110 optionally replaces the binary code with the other binary code. Optionally, processor 110 executes 501 and 510 in one or more server iterations when remote server sends the new binary code in 418.

Reference is now made again to FIG. 4. In 420 remote server 102 optionally computes a plurality of digital signatures, each computed one of the plurality of messages and in 422 remote server 102 optionally associates a maliciousness score to each of the plurality of messages. Optionally the maliciousness score is computed using the classification model. In 425 remote server 102 optionally stores the plurality of messages as a plurality of historical messages in one or more non-volatile storages 103. Optionally, each of the plurality of messages is stores with respective maliciousness score and respective digital signature. Optionally, remote processor 102 trains the classification model using the plurality of historical messages, including respective maliciousness score.

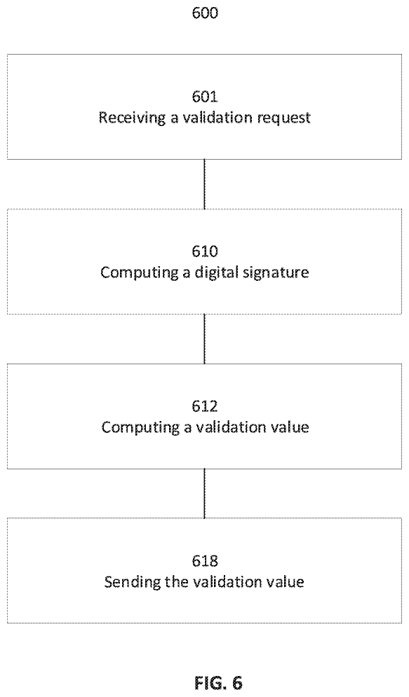

To respond to the validation request sent by processor 110 in 240 above, system 100 optionally implements the following method. Reference is now made also to FIG. 6, showing a flowchart schematically representing an optional flow of operations 600 for validating a message on a server, according to some embodiments of the present invention. In such embodiments, in 601 remote server 102 receives a validation request from device 101. Optionally, the validation request comprises at least part of the message. In 610, remote processor 101 optionally computes a digital signature using the at least part of the message, and in 612 remote server 102 optionally computes a validation value by comparing the digital signature to a plurality of digital signatures of the plurality of historical messages. For example, remote server 102 may identify one or more of the plurality of historical messages having respective digital signatures equal to the digital signature and may compute the validation value using the respective maliciousness scores of the identified on or more historical message. Optionally, the validation value is a binary validation value, selected from a group consisting of two identified validation values, for example true and false. In 618, remote server optionally sends the validation value to device 101.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant network connected devices will be developed and the scope of the term network connected device is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A secure network system comprising:
at least one secured network connected device, comprising at least one hardware processor connected to at least one digital communication network interface, and adapted for:
in at least one iteration of a plurality of iterations:
executing a binary code for computing a maliciousness score in response to an input message, where the binary code is received from a remote server via a network and encapsulates a classification model trained, using a plurality of historical messages collected by the remote server from a plurality of secured network connected devices, to compute the maliciousness score in response to the input message;
receiving a message via the at least one digital communication network interface;
computing a message maliciousness score by providing the message to the binary code; and
providing the message to at least one software object executed by the at least one hardware processor to perform a message oriented task, subject to the message maliciousness score.

2. The system of claim 1, wherein the binary code encapsulates a plurality of hardware components and a plurality of software components of the classification model.

3. The system of claim 1, wherein the at least one digital communication network interface is connected to a wireless digital communication network.

4. The system of claim 3, wherein the wireless digital communication network is selected from a group consisting of: a network based on Institute of Electrical and Electronics Engineers (IEEE) 802.15.4 technical standard, and a cellular network.

5. The system of claim 4, wherein the network based on IEEE 802.15.4 technical standard is a Zigbee Alliance Zigbee network.

6. The system of claim 4, where in the cellular network is a Global System for Mobile communications (GSM) network.

7. The system of claim 1, wherein the classification model is a neural network.

8. The system of claim 7, wherein the neural network comprises a plurality of computation units and a plurality of node connections, each node connection having a source node of the plurality of computation units, a target node of the plurality of computation units, and a plurality of connection values;
wherein the binary code encapsulates a plurality of compressed computation units, each a compressed representation of one of the plurality of computation units, and a plurality of compressed node connections, each a compressed representation of one of the plurality of node connections; and
wherein executing the binary code comprises:
expanding at least some of the compressed computation units to produce a plurality of expanded computation units; and
in at least one of a plurality of classification iterations:
executing at least one of the expanded computation units;
expanding at least one of the plurality of compressed node connections having a source node equal to the at least one of the expanded computation units to produce an expanded node connection; and
executing the target node of the expanded node connection according to an output of the source node and the plurality of connection values of the expanded node connection.

9. The system of claim 1, wherein the at least one hardware processor is further adapted for:
in the at least one iteration:
receiving another message via the at least one digital communication network interface;
computing another message maliciousness score by providing the other message to the binary code; and
providing the other message to the at least one software object to perform the message oriented task, subject to the other message maliciousness score.

10. The system of claim 1, wherein the at least one hardware processor is further adapted for:
in at least one other iteration of the plurality of iterations:
receiving from the remote server, via the network, another binary code for computing a maliciousness score in response to an input message; where the other binary code encapsulates the classification model further trained, using another plurality of historical messages collected by the remote server from the plurality of secured network connected devices, to compute the maliciousness score in response to the input message; and
replacing the binary code with the other binary code.

11. The system of claim 1, wherein the at least one hardware processor is connected to the network via at least one other digital communication network interface.

12. The system of claim 1, wherein the at least one hardware processor is further adapted for:
sending the message to the remote server for training the classification model.

13. The system of claim 1, wherein the at least one hardware processor is further adapter for:
identifying at least one signature-based anomaly by computing a match between the message and at least one identified signature value; and
refraining from providing the message to the binary code subject to identifying the at least one signature based anomaly.

14. The system of claim 13, wherein the at least one identified signature value is a regular expression string value.

15. The system of claim 1, wherein the at least one hardware processor is further adapted for:
classifying the message as malformed, subject to a result of applying at least one message-format test to the message;
sending a validation request, comprising at least part of the message, to the remote server for classification;
receiving from the remote server a validation value; and
refraining from providing the message to the other software object subject to the validation value.

16. The system of claim 1, wherein the at least one hardware processor is further adapted for:
classifying the message as verified, subject to a result of applying at least one syntax test to the message; and
providing the message to the at least one software object instead of computing the message maliciousness score and providing the message to the at least one software object subject to the message maliciousness score.

17. The system of claim 16, wherein the at least one digital communication interface is connected to a GSM network; and
wherein applying the at least one syntax test comprises at least one of: comparing a command value extracted from the message to an identified command value; comparing a flag value extracted from the message to an identified flag value; comparing an amount of bytes of the message to an identified amount of bytes, comparing an encryption method value identified in the message to an identified encryption method value, and comparing a routing attribute value extracted from the message to an identified routing attribute value.

18. A method for a secured network connected device, comprising:
in at least one iteration of a plurality of iterations:
executing a binary code for computing a maliciousness score in response to an input message, where the binary code is received from a remote server via a network and encapsulates a classification model trained, using a plurality of historical messages collected by the remote server from a plurality of secured network connected devices, to compute the maliciousness score in response to the input message;
receiving a message via the at least one digital communication network interface;
computing a message maliciousness score by providing the message to the binary code; and
providing the message to at least one software object executed by at least one hardware processor of the secured network connected device to perform a message oriented task, subject to the message maliciousness score.

19. A secure network system comprising:
at least one server, comprising at least one hardware processor adapted for:
in each of a plurality of server iterations:
receiving from a plurality of secured network devices a plurality of messages;
training a classification model to compute a maliciousness score in response to an input message;
producing a binary code encapsulating the classification model; and
sending the binary code, via a network, to at least one secured network connected device.

20. The system of claim 19, wherein the at least one hardware processor is further adapted for:
computing a plurality of digital signatures, each computed using one of the plurality of messages;
associating a maliciousness score to each of the plurality of messages; and
storing the plurality of messages as a plurality of historical messages in at least one non-volatile digital storage connected to the at least one hardware processor, each of the plurality of messages stored with respective maliciousness score and respective digital signature.

21. The system of claim 20, wherein the at least one hardware processor is further adapted for:
in at least one of a plurality of validation iterations:
receiving from the at least one secured network connected device a validation request, comprising at least part of a message;
computing a digital signature using the at least part of the message;
computing a validation value by comparing the digital signature to a plurality of digital signatures of the plurality of historical messages; and
sending the validation value to the at least one secured network connected device.

22. A method for a server of a secure network, comprising:
in each of a plurality of server iterations:
receiving from a plurality of secured network devices a plurality of messages;
training a classification model to compute a maliciousness score in response to an input message;
producing a binary code encapsulating the classification model; and
sending the binary code, via a network, to at least one secured network connected device.

23. A method for a secure network system, comprising:
on at least one remote server:
in each of a plurality of server iterations:
receiving from a plurality of secured network devices a plurality of messages;
training a classification model to compute a maliciousness score in response to an input message;
producing a binary code encapsulating the classification model; and
sending the binary code, via a network, to at least one secured network connected device; and
on the at least one secured network connected device:
in at least one iteration of a plurality of iterations:
receiving the binary code from the at least one remote server;
executing the binary code;
receiving a message via at least one digital communication network interface;
computing a message maliciousness score by providing the message to the binary code; and
providing the message to at least one software object executed by the at least one hardware processor to perform a message oriented task, subject to the message maliciousness score.

24. A secure network system comprising:
at least one remote server, comprising at least one server hardware processor adapted for:
in each of a plurality of server iterations:
receiving from a plurality of secured network devices a plurality of messages;
training a classification model to compute a maliciousness score in response to an input message;
producing a binary code encapsulating the classification model; and
sending the binary code, via a network, to at least one secured network connected device; and
at least one secured network connected device, comprising at least one hardware processor connected to at least one digital communication network interface, and adapted for:
in at least one iteration of a plurality of iterations:
receiving the binary code from the at least one remote server;
executing the binary code;
receiving a message via at least one digital communication network interface;
computing a message maliciousness score by providing the message to the binary code; and
providing the message to at least one software object executed by the at least one hardware processor to perform a message oriented task, subject to the message maliciousness score.
